(19) United States
(12) Patent Application Publication
(10) Pub. No.: US 2025/0136516 A1
(43) Pub. Date: May 1, 2025

(54) CERAMIC COMPOSITION AND COIL COMPONENT

(71) Applicant: Murata Manufacturing Co., Ltd., Kyoto-fu (JP)

(72) Inventor: Yuuki KITADAI, Nagaokakyo-shi (JP)

(73) Assignee: Murata Manufacturing Co., Ltd., Kyoto-fu (JP)

(21) Appl. No.: 18/816,912

(22) Filed: Aug. 27, 2024

(30) Foreign Application Priority Data
Oct. 31, 2023 (JP) 2023-186575

(51) Int. Cl. C04B 35/26; H01F 27/24; H01F 27/28; H01F 27/29

(52) U.S. Cl. CPC C04B 35/265; H01F 27/24; H01F 27/2828; H01F 27/292; C04B 2235/3262; C04B 2235/3272; C04B 2235/3275; C04B 2235/3279; C04B 2235/3281; C04B 2235/3284

(57) ABSTRACT

A ceramic composition contains Fe, Cu, Zn, Mn, Co, Ni, Y, and Cr, and when the Fe, the Cu, the Zn, the Mn, the Co, and the Ni are expressed in terms of Fe₂O₃, CuO, ZnO, MnO, CoO, and NiO, respectively, and a total amount of the Fe₂O₃, the CuO, the ZnO, the MnO, the CoO, and the NiO is set to 100 mol %, the ceramic composition contains the Fe of an amount from 41.9 mol % to 49.2 mol % in terms of the Fe₂O₃, the Cu of an amount from 4.4 mol % to 7.5 mol % in terms of the CuO, the Zn of an amount from 21.9 mol % to 36.0 mol % in terms of the ZnO, the Mn of an amount from 0.043 mol % to 0.867 mol % in terms of the MnO, and the Co of an amount from 0.0004 mol % to 1.2293 mol % in terms of the CoO.

### CROSS-REFERENCE TO RELATED APPLICATION

This application claims benefit of priority to Japanese Patent Application No. 2023-186575, filed Oct. 31, 2023, the entire content of which is incorporated herein by reference.

### BACKGROUND

### Technical Field

The present disclosure relates to a ceramic composition and a coil component.

### Background Art

Japanese Unexamined Patent Application Publication No. 2018-125397 discloses a winding-type coil device using a drum core including a winding core portion and flange portions. According to the coil device described in Japanese Unexamined Patent Application Publication No. 2018-125397, a first protruding portion for mounting formed on the flange portion at one end of the winding core portion and a second protruding portion for mounting formed on the flange portion at the other end of the winding core portion are disposed so as to be displaced from each other, which makes the coil device excellent in thermal shock resistance characteristics.

### SUMMARY

Japanese Unexamined Patent Application Publication No. 2018-125397 describes that a drum core is produced by molding and sintering a ferrite material such as a Ni—Zn-based ferrite or a Mn—Zn-based ferrite.

A manufacturing process of a drum core of a winding-type coil device typically includes obtaining a sintered body by molding and firing a powder of a ferrite material, then, in a semi-finished product state, further applying heat (reheating) in order to bake electrodes to be formed on drum core leg portions, and the like. However, the drum core manufactured by using the ferrite material described in Japanese Unexamined Patent Application Publication No. 2018-125397 has a possibility that a strength is reduced due to an impact received during transportation or an additional process such as barrel polishing, which causes a sufficient mounting strength not to be obtained.

Accordingly, the present disclosure provides a ceramic composition having a high initial flexural strength and a high flexural strength after reheating, and having a high insulation resistance. Further, the present disclosure provides a coil component including a ceramic core constituted by the ceramic composition described above.

A ceramic composition of the present disclosure contains Fe, Cu, Zn, Mn, Co, Ni, Y, and Cr, and when the Fe, the Cu, the Zn, the Mn, the Co, and the Ni are expressed in terms of Fe₂O₃, CuO, ZnO, MnO, CoO, and NiO, respectively, and a total amount of the Fe₂O₃, the CuO, the ZnO, the MnO, the CoO, and the NiO is set to 100 mol %, the ceramic composition contains the Fe of an amount equal to or more than 41.9 mol % and equal to or less than 49.2 mol % (i.e., from 41.9 mol % to 49.2 mol %) in terms of the Fe₂O₃, the Cu of an amount equal to or more than 4.4 mol % and equal to or less than 7.5 mol % (i.e., from 4.4 mol % to 7.5 mol %) in terms of the CuO, the Zn of an amount equal to or more than 21.9 mol % and equal to or less than 36.0 mol % (i.e., from 21.9 mol % to 36.0 mol %) in terms of the ZnO, the Mn of an amount equal to or more than 0.043 mol % and equal to or less than 0.867 mol % (i.e., from 0.043 mol % to 0.867 mol %) in terms of the MnO, the Co of an amount equal to or more than 0.0004 mol % and equal to or less than 1.2293 mol % (i.e., 0.0004 mol % to 1.2293 mol %) in terms of the CoO, and the Ni of the remaining amount. Additionally, relative to 100 parts by weight of the total amount of the Fe₂O₃, the CuO, the ZnO, the MnO, the CoO, and the NiO, the ceramic composition contains the Y of an amount equal to or more than 5 ppm and equal to or less than 800 ppm (i.e., from 5 ppm to 800 ppm) in terms of Y₂O₃ and the Cr of an amount equal to or more than 5 ppm and equal to or less than 800 ppm (i.e., from 5 ppm to 800 ppm) in terms of Cr₂O₃.

A coil component according to the present disclosure includes a ceramic core constituted by the ceramic composition according to the present disclosure.

According to the present disclosure, a ceramic composition having a high initial flexural strength and a high flexural strength after reheating, and a high insulation resistance can be provided. Furthermore, according to the present disclosure, a coil component including a ceramic core constituted by the above-described ceramic composition can be provided.

### BRIEF DESCRIPTION OF THE DRAWINGS

FIG. 1 is a front view schematically showing an example of a coil component of the present disclosure; and

FIG. 2 is a perspective view schematically showing an example of a ceramic core constituting the coil component illustrated in FIG. 1.

### DETAILED DESCRIPTION

Hereinafter, a ceramic composition and a coil component of the present disclosure will be described.

However, the present disclosure is not limited to the following configurations, and can be appropriately modified and applied within a range not departing from the gist of the present disclosure. Note that the present disclosure also includes combinations of two or more of the individual desirable configurations of the present disclosure, which will be described below.

### Ceramic Composition

According to the present disclosure, a ceramic composition contains Fe, Cu, Zn, Mn, Co, Ni, Y, and Cr. According to the present disclosure, a ceramic composition contains, for example, a ferrite, preferably a spinel-type ferrite as a main component.

In the present specification, the ceramic composition means a sintered body, and preferably means a core-shaped sintered body. Therefore, in the present disclosure, the ceramic composition is a mixture of the above-described atoms at an atomic level. That is, in the present disclosure, the ceramic composition is synonymous with a ferrite sintered body.

In the present disclosure, when the Fe, the Cu, the Zn, the Mn, the Co, and the Ni are expressed in terms of the Fe₂O₃, the CuO, the ZnO, the MnO, the CoO, and the NiO, respectively, and the total amount of the Fe₂O₃, the CuO, the ZnO, the MnO, the CoO, and the NiO is set to 100 mol %, the ceramic composition contains the Fe of an amount equal to or more than 41.9 mol % and equal to or less than 49.2 mol % (i.e., from 41.9 mol % to 49.2 mol %) in terms of the Fe₂O₃, the Cu of an amount equal to or more than 4.4 mol % and equal to or less than 7.5 mol % (i.e., from 4.4 mol % to 7.5 mol %) in terms of the CuO, the Zn of an amount equal to or more than 21.9 mol % and equal to or less than 36.0 mol % (i.e., from 21.9 mol % to 36.0 mol %) in terms of the ZnO, the Mn of an amount equal to or more than 0.043 mol % and equal to or less than 0.867 mol % (i.e., from 0.043 mol % to 0.867 mol %) in terms of the MnO, the Co of an amount equal to or more than 0.0004 mol % and equal to or less than 1.2293 mol % (i.e., from 0.0004 mol % to 1.2293 mol %) in terms of the CoO, and the Ni of the remaining amount.

In the present disclosure, relative to 100 parts by weight of the total amount of the Fe₂O₃, the CuO, the ZnO, the MnO, the CoO, and the NiO, the ceramic composition further contains the Y of an amount equal to or more than 5 ppm and equal to or less than 800 ppm (i.e., from 5 ppm to 800 ppm) in terms of the Y₂O₃ and the Cr of an amount equal to or more than 5 ppm and equal to or less than 800 ppm (i.e., from 5 ppm to 800 ppm) in terms of the Cr₂O₃.

In the ceramic composition of the present disclosure, setting the contents of Fe, Cu, Zn, Mn, Co, Ni, Y and Cr within the above-mentioned ranges can increase an initial flexural strength and a flexural strength after reheating, and also increase an insulation resistance. For example, a ceramic composition having an initial flexural strength equal to or larger than 190 N, a flexural strength after reheating equal to or larger than 200 N, and an electric resistance equal to or larger than 10 by logarithmic expression, which will be described in Examples later, can be obtained.

In the present disclosure, when the Fe, the Cu, the Zn, the Mn, the Co, and the Ni are expressed in terms of the Fe₂O₃, the CuO, the ZnO, the MnO, the CoO, and the NiO, respectively, and the total amount of the Fe₂O₃, the CuO, the ZnO, the MnO, the CoO, and the NiO is set to 100 mol %, the ceramic composition preferably contains the Fe of an amount equal to or more than 44.4 mol % and equal to or less than 49.2 mol % (i.e., from 44.4 mol % to 49.2 mol %) in terms of the Fe₂O₃, the Zn of an amount equal to or more than 26.9 mol % and equal to or less than 33.0 mol % (i.e., from 26.9 mol % to 33.0 mol %) in terms of the ZnO, and the Co of an amount equal to or more than 0.0004 mol % and equal to or less than 0.2500 mol % (i.e., from 0.0004 mol % to 0.2500 mol %) in terms of the CoO.

In the ceramic composition of the present disclosure, setting the contents of Fe, Zn and Co within the above-mentioned preferable ranges can increase the initial flexural strength, the flexural strength after reheating and the insulation resistance, and also increase an initial permeability and a Curie temperature. For example, a ceramic composition having an initial flexural strength equal to or more than 190 N, a flexural strength after reheating equal to or more than 200 N, an electric resistance equal to or more than 10 by logarithmic expression, an initial permeability μ′ equal to or more than 400, and a Curie temperature equal to or more than 150° C., which will be described in Examples later, can be obtained.

In the present disclosure, relative to 100 parts by weight of the total amount of the Fe₂O₃, the CuO, the ZnO, the MnO, the CoO, and the NiO, the ceramic composition preferably contains the Y of an amount equal to or more than 5 ppm and equal to or less than 600 ppm (i.e., from 5 ppm to 600 ppm) in terms of the Y₂O₃. In the ceramic composition of the present disclosure, setting the content of Y within the above-mentioned preferable range can further increase the flexural strength after reheating. For example, a ceramic composition having a flexural strength after reheating equal to or more than 210 N and a strength increase rate, which is obtained by comparing the initial flexural strength and the flexural strength after reheating, equal to or more than 110% can be obtained, which will be described in Examples later. Y of an amount equal to or more than 50 ppm and equal to or less than 600 ppm (i.e., from 50 ppm to 600 ppm) in terms of Y₂O₃ is more preferably contained.

In the present disclosure, the content of Y in the ceramic composition may be, for example, equal to or less than 400 ppm, in terms of Y₂O₃, relative to 100 parts by weight of the total amount of Fe₂O₃, CuO, ZnO, MnO, CoO, and NiO.

In the present disclosure, the ceramic composition preferably contains the Cr of an amount equal to or more than 10 ppm and equal to or less than 600 ppm (i.e., from 10 ppm to 600 ppm) in terms of the Cr₂O₃, relative to 100 parts by weight of the total amount of the Fe₂O₃, the CuO, the ZnO, the MnO, the CoO and, the NiO. In the ceramic composition according to the present disclosure, setting the content of Cr within the above-mentioned preferable range can further increase the flexural strength after reheating. For example, a ceramic composition having a flexural strength after reheating equal to or more than 210 N and a strength increase rate, which is obtained by comparing the initial flexural strength and the flexural strength after reheating, equal to or more than 110% can be obtained, which will be described in Examples later. Cr of an amount equal to or more than 50 ppm and equal to or less than 600 ppm (i.e., from 50 ppm to 600 ppm) in terms of Cr₂O₃ is more preferably contained.

In the present disclosure, the content of Cr in the ceramic composition may be, for example, equal to or less than 400 ppm in terms of Cr₂O₃, relative to 100 parts by weight of the total amount of Fe₂O₃, CuO, ZnO, MnO, CoO, and NiO.

In the present disclosure, the content of each of the elements can be determined by analyzing a composition of the ceramic composition by using inductively coupled plasma atomic emission/mass spectrometry (ICP-AES/MS).

In the present disclosure, the ceramic composition may further contain other elements. Further, in the present disclosure, the ceramic composition may further contain inevitable impurities. Examples of the inevitable impurities include typical metals such as B, C, Si, S, Cl, As, Br, I, Li, Na, Mg, Al, K, Ca, Ga, Ge, Sr, Cd, In, Sn, Sb, Ba, Pb, and Bi, and transition metals such as Sc, Ti, V, Nb, Mo, Pd, Ag, and Hf.

In the present disclosure, the ceramic composition is preferably manufactured as follows.

First, Fe₂O₃, CuO, ZnO, NiO, MnO, CoO, Y₂O₃, and Cr₂O₃ are weighed in such a manner that a composition after firing becomes a predetermined composition, and the mixed raw material thereof is put into a ball mill together with pure water and partially stabilized zirconia (PSZ) balls, and mixed and crushed in a wet manner for a predetermined time period (for example, a time period equal to or more than 4 hours and equal to or less than 8 hours (i.e., from 4 hours to 8 hours)). The crushed mixture is evaporated and dried, and then calcined at a predetermined temperature (for example, temperature equal to or more than 700° C. and equal to or less than 800° C. (i.e., from 700° C. to 800° C.)) for a predetermined time period (for example, a time period equal to or more than 2 hours and equal to or less than 5 hours (i.e., from 2 hours to 5 hours)) to prepare a calcined product (calcined powder).

The obtained calcined product (calcined powder) is put into a ball mill together with pure water, polyvinyl alcohol as a binder, a dispersant, a plasticizer, and PSZ balls, and mixed and crushed in a wet manner. The mixed and crushed slurry is dried and granulated by a spray dryer to prepare a granular powder.

A mold is prepared, and the prepared granular powder is pressurized and molded to form a molded body.

Next, the molded body is fired by being held in a firing furnace at a predetermined temperature (for example, temperature equal to or more than 1000° C. and equal to or less than 1200° C. (i.e., from 1000° C. to 1200° C.)) for a predetermined time period (for example, time period equal to or more than 2 hours and equal to or less than 5 hours (i.e., from 2 hours to 5 hours)). The ceramic composition is obtained by the above process.

The formation of a ferrite is represented by, for example, the following chemical formula.

MO+Fe₂O₃→MFe₂O₄

Here, M represents a metal such as Zn, Ni, Cu, Mn, or Co.

In the present disclosure, designing the ceramic composition to have a composition having surplus MO or Fe₂O₃ intentionally or using an impurity causes a state in which a ferrite formation reaction easily occurs at the time of reheating, resulting in repairing a flaw that becomes a fracture origin.

In the present disclosure, further, the effect of improving the flexural strength of the ceramic composition after reheating can be obtained by optimizing both Y₂O₃ acting on M and Cr₂O₃ acting on Fe in the MFe₂O₄.

By setting Y₂O₃ in the ceramic composition to be equal to or more than 5 ppm and equal to or less than 800 ppm (i.e., from 5 ppm to 800 ppm) relative to 100 parts by weight of the total amount of Fe₂O₃, CuO, ZnO, MnO, CoO, and NiO, ZnO and CuO that contribute to diffusion at the time of reheating that is performed later are trapped during firing, so that a ferrite reaction is likely to occur at the time of reheating, and the strength of the ceramic composition is likely to be further improved. When Y₂O₃ exceeds 800 ppm, heterogeneous phases constituted by a large number of unreacted substances are formed in the ferrite, a fracture origin is formed, and thus, the sufficient strength (the initial flexural strength and the flexural strength after reheating) cannot be obtained.

Setting Cr₂O₃ in the ceramic composition to be equal to or more than 5 ppm and equal to or less than 800 ppm (i.e., from 5 ppm to 800 ppm) relative to 100 parts by weight of the total amount of Fe₂O₃, CuO, ZnO, MnO, CoO, and NiO suppresses the reaction of Fe₂O₃ during firing, and leaves Fe₂O₃ until the time of reheating, which facilitates the ferrite reaction during reheating, and thus causes the strength to be easily improved. When Cr₂O₃ exceeds 800 ppm, a spinel phase derived from Cr is generated in the ferrite and becomes a fracture origin, and the sufficient strength (initial flexural strength and flexural strength after reheating) cannot be obtained.

The ceramic composition according to the present disclosure is used, for example, for a ceramic core of a coil component, and is particularly suitably used for a ceramic core of a winding-type coil component. Note that the use of the ceramic composition according to the present disclosure is not particularly limited, and the ceramic composition may be used for an element body such as a laminated inductor.

### Coil Component

A coil component according to the present disclosure includes a ceramic core constituted by the ceramic composition according to the present disclosure.

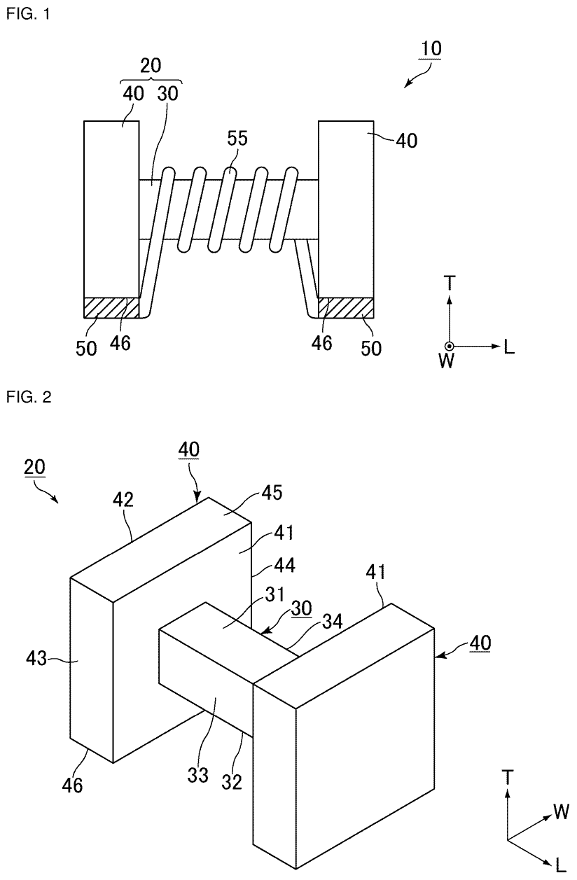

FIG. 1 is a front view schematically showing an example of a coil component according to the present disclosure. FIG. 2 is a perspective view schematically showing an example of a ceramic core constituting the coil component shown in FIG. 1.

FIG. 1 and FIG. 2 are schematically shown, and the scale of dimensions and aspect ratios of the drawings may be different from that of actual products.

In the following description, a term indicating a relationship between elements (for example, “perpendicular”, “parallel”, “orthogonal”, or the like) and a term indicating a shape of an element are not only expressions in strict meaning, but expressions within a substantially equivalent range, for example, expressions including a difference of about several percent.

A coil component 10 shown in FIG. 1 is a winding-type coil component, and includes a ceramic core 20, terminal electrodes 50, and a wire (coil) 55. The ceramic core 20 is constituted by the ceramic composition according to the present disclosure.

As shown in FIG. 1 and FIG. 2, the ceramic core 20 includes a winding core portion 30 extending in a length direction L, and a pair of flange portions 40 provided at both end portions of the winding core portion 30 facing each other in the length direction L. The winding core portion 30 and the flange portions 40 are integrally formed.

In the present specification, as shown in FIG. 1 and FIG. 2, a direction in which the pair of flange portions 40 are aligned is defined as the length direction L, a vertical direction in FIG. 1 and FIG. 2 among directions orthogonal to the length direction L is defined as a height direction (thickness direction) T, and a direction orthogonal to both the length direction L and the height direction T is defined as a width direction W.

The winding core portion 30 is formed in a rectangular parallelepiped shape extending in the length direction L, for example. A central axis of the winding core portion 30 extends in parallel to the length direction L. The winding core portion 30 includes a pair of main surfaces 31 and 32 opposed to each other in the height direction T and a pair of side surfaces 33 and 34 opposed to each other in the width direction W.

In the present specification, the rectangular parallelepiped shape includes a rectangular parallelepiped with chamfered corners and ridges, a rectangular parallelepiped with rounded corners and ridges, and the like. Further, unevenness or the like may be formed on a part or the whole of the main surfaces and the side surfaces.

The pair of flange portions 40 are provided at the both end portions of the winding core portion 30 in the length direction L. Each flange portion 40 is formed in a rectangular parallelepiped shape that is thin in the length direction L. Each flange portion 40 is formed so as to protrude around the winding core portion 30 toward the height direction T and the width direction W. Specifically, a planar shape of each flange portion 40 when viewed from the length direction L is formed so as to protrude in the height direction T and the width direction W relative to the winding core portion 30.

Each flange portion 40 includes an inner end surface 41 facing the winding core portion 30 side in the length direction L, an outer end surface 42 on an opposite side to the inner end surface 41 in the length direction L, a pair of side surfaces 43 and 44 opposed to each other in the width direction W, and a top surface 45 and a bottom surface 46 opposed to each other in the height direction T. The inner end surface 41 of one of the flange portions 40 is disposed so as to face the inner end surface 41 of the other of the flange portions 40.

The inner end surface 41 of each flange portion 40 is formed such that, for example, the entire surface thereof extends perpendicularly to the direction in which the central axis of the winding core portion 30 extends (here, the length direction L). That is, the entire inner end surface 41 of each flange portion 40 is formed so as to extend in parallel to the height direction T. However, an inclined surface may be formed at the inner end surface 41 of each flange portion 40.

As shown in FIG. 1, each of the terminal electrodes 50 is provided at least on the bottom surface 46 of respective one of the flange portions 40. For example, when the coil component 10 is mounted on a circuit board, each of the terminal electrodes 50 is electrically coupled to an electrode of the circuit board. The terminal electrodes 50 are made of, for example, a Ni-based alloy such as nickel (Ni)-chromium (Cr) or Ni-copper (Cu), sliver (Ag), Cu, tin (Sn), or the like.

The wire 55 is wound around the winding core portion 30. The wire 55 has a structure in which a core wire mainly made of a conductive material such as Cu is covered with an insulating material such as polyurethane or polyester. Each of both end portions of the wire 55 is electrically coupled to respective one of the terminal electrodes 50.

Although not shown in FIG. 1, a plurality of terminal electrodes 50 may be provided on the bottom surface 46 of each flange portion 40. Further, a plurality of wires 55 may be wound around the winding core portion 30.

In the present disclosure, the coil component is manufactured, for example, as follows.

As described in the above [Ceramic Composition], the granular powder is pressurized and molded to form the molded body. Next, the molded body is fired by being held in a firing furnace at a predetermined temperature (for example, temperature equal to or more than 1000° C. and equal to or less than 1200° C. (i.e., from 1000° C. to 1200° C.)) for a predetermined time period (for example, time period equal to or more than 2 hours and equal to or less than 5 hours (i.e., from 2 hours to 5 hours)). The obtained sintered body is put into a barrel and polished with a polishing material. The barrel polishing removes burrs from the sintered body, and an outer surface (particularly, corner portions and ridge portions) of the sintered body is rounded to have a curved shape. The ceramic core as shown in FIG. 2 is obtained by the above process.

Subsequently, each of the terminal electrodes is formed on at least the bottom surface of respective one of the flange portions of the ceramic core. For example, a conductive paste including Ag, a glass frit, and the like is applied to the bottom surface of each flange portion, a baking process is performed at a predetermined temperature (for example, temperature equal to or more than 850° C. and equal to or less than 950° C. (i.e., from 850° C. to 950° C.)) to form an underlying metal layer, and then a Ni plating film and a Sn plating film are sequentially formed on the underlying metal layer by electrolytic plating to form a plating layer. The plating layer may contain copper (Cu) as a constituent component. Alternatively, a metal terminal may be attached to the bottom surface of each flange portion to be used as respective one of the terminal electrodes. For example, the baking process for forming the underlying metal layer corresponds to the reheating process.

Next, after a wire is wound around the winding core portion of the ceramic core, an end portion of the wire and each terminal electrode are bonded to each other by a known method such as thermocompression bonding. Through the above process, the coil component such as the winding-type coil component shown in FIG. 1 can be manufactured.

The coil component according to the present disclosure is not limited to the above-described embodiment, and various applications and modifications can be made within the scope of the present disclosure. As another shape, for example, a top plate extending in the length direction L and coupling between the flange portions may be provided. The wire may be, for example, a wire in which a core wire containing a conductive material such as Cu as a main component is covered with an insulating material such as polyurethane or polyester. The shape of the core is not limited to a drum core, and may be an annular core.

In the coil component according to the present disclosure, the shape and size of the winding core portion of the ceramic core, the shape and size of each flange portion of the ceramic core, the thickness (wire diameter) of the wire, the number of turns, the cross-sectional shape of the wire, and the number of wires are not particularly limited, and can be appropriately changed according to desired characteristics and a mounting place. In addition, the positions and the number of the terminal electrodes can be appropriately set according to the number of wires and the use thereof.

The present specification discloses the following contents.

<1> A ceramic composition contains Fe, Cu, Zn, Mn, Co, Ni, Y, and Cr, and when the Fe, the Cu, the Zn, the Mn, the Co, and the Ni are expressed in terms of Fe₂O₃, CuO, ZnO, MnO, CoO, and NiO, respectively, and a total amount of the Fe₂O₃, the CuO, the ZnO, the MnO, the CoO, and the NiO is set to 100 mol %, the ceramic composition contains the Fe of an amount equal to or more than 41.9 mol % and equal to or less than 49.2 mol % (i.e., from 41.9 mol % to 49.2 mol %) in terms of the Fe₂O₃, the Cu of an amount equal to or more than 4.4 mol % and equal to or less than 7.5 mol % (i.e., from 4.4 mol % to 7.5 mol %) in terms of the CuO, the Zn of an amount equal to or more than 21.9 mol % and equal to or less than 36.0 mol % (i.e., from 21.9 mol % to 36.0 mol %) in terms of the ZnO, the Mn of an amount equal to or more than 0.043 mol % and equal to or less than 0.867 mol % (i.e., from 0.043 mol % to 0.867 mol %) in terms of the MnO, the Co of an amount equal to or more than 0.0004 mol % and equal to or less than 1.2293 mol % (i.e., from 0.0004 mol % to 1.2293 mol %) in terms of the CoO, and the Ni of the remaining amount, and relative to 100 parts by weight of the total amount of the Fe₂O₃, the CuO, the ZnO, the MnO, the CoO, and the NiO, the ceramic composition contains the Y of an amount equal to or more than 5 ppm and equal to or less than 800 ppm (i.e., from 5 ppm to 800 ppm) in terms of Y₂O₃ and the Cr of an amount equal to or more than 5 ppm and equal to or less than 800 ppm (i.e., from 5 ppm to 800 ppm) in terms of Cr₂O₃.

<2> The ceramic composition according to <1>, wherein the Fe of an amount equal to or more than 44.4 mol % and equal to or less than 49.2 mol % (i.e., from 44.4 mol % to 49.2 mol %) in terms of the Fe₂O₃, the Zn of an amount equal to or more than 26.9 mol % and equal to or less than 33.0 mol % (i.e., from 26.9 mol % to 33.0 mol %) in terms of the ZnO, and the Co of an amount equal to or more than 0.0004 mol % and equal to or less than 0.2500 mol % (i.e., from 0.0004 mol % to 0.2500 mol %) in terms of the CoO are contained.

<3> The ceramic composition according to <1> or <2>, wherein the Y of an amount equal to or more than 5 ppm and equal to or less than 600 ppm (i.e., from 5 ppm to 600 ppm) in terms of the Y₂O₃ is contained, relative to 100 parts by weight of the total amount of the Fe₂O₃, the CuO, the ZnO, the MnO, the CoO and, the NiO.

<4> The ceramic composition according to any one of <1> to <3>, wherein the Cr of an amount equal to or more than 10 ppm and equal to or less than 600 ppm (i.e., from 10 ppm to 600 ppm) in terms of the Cr₂O₃ is contained, relative to 100 parts by weight of the total amount of the Fe₂O₃, the CuO, the ZnO, the MnO, the CoO, and the NiO.

<5> A coil component including a ceramic core constituted by the ceramic composition according to any one of <1> to <4>.

<6> The coil component according to <5>, wherein the ceramic core includes a winding core portion extending in a length direction, and a pair of flange portions provided at both end portions of the winding core portion opposed to each other in the length direction, each of the flange portions including an inner end surface facing the winding core portion side in the length direction, an outer end surface on an opposite side to the inner end surface in the length direction, a pair of side surfaces opposed to each other in a width direction, and a top surface and a bottom surface opposed to each other in a height direction, a terminal electrode is provided on at least the bottom surface of each of the flange portions of the ceramic core, and a wire is wound around the winding core portion of the ceramic core, and an end portion of the wire is electrically coupled to the terminal electrode.

### EXAMPLES

Examples in which the ceramic composition according to the present disclosure is more specifically disclosed will be described below. Note that the present disclosure is not limited to these examples.

### Example 1

Fe₂O₃, CuO, ZnO, NiO, MnO, CoO, Y₂O₃, and Cr₂O₃ were weighed in a manner that a composition after firing was a composition shown in Table 1, and the mixed raw material thereof was put into a ball mill together with pure water and PSZ balls, and mixed and crushed for 4 hours in a wet manner. The crushed mixture was evaporated and dried, and then calcined at 800° C. for 2 hours to prepare a calcined product.

The prepared calcined product was put into a ball mill together with pure water, polyvinyl alcohol as a binder, a dispersant, a plasticizer, and PSZ balls, and mixed and crushed. The mixed and crushed slurry was dried and granulated by a spray dryer to prepare a granular powder.

The prepared granular powder was pressurized and molded to prepare a molded body having the following dimensions after molding.

A single-plate sample having a dimension of 4.0 mm in the length direction L, a dimension of 2.0 mm in the width direction W, and a dimension of 1.5 mm in the height direction T, or a ring-shaped sample having an outer diameter of 20 mm, an inner diameter of 12 mm, and a thickness of 1.5 mm

The prepared molded body was fired at 1100° C. for 2 hours. In this way, single-plate samples of Samples 1 to 37 and ring-shaped samples of Samples 1 to 37 were prepared.

For each sample, the composition of the sintered body was analyzed by using ICP-AES/MS to measure the content of each element. The results are shown in Table 1. Table 1 shows the contents of the respective elements in terms of oxides thereof.

### Initial Flexural Strength

Flexural strengths of the single-plate samples of Samples 1 to 37 were measured by a three-point bending test performed by using MODEL-1311VCW manufactured by Aikoh Engineering Co., Ltd., and in the three-point bending test, a terminal having an indenter radius of 0.5 mm was lowered at 5 mm/min toward the central portion of an inter-fulcrum distance of 3.2 mm. Ten samples were measured for each type of the samples. Average values thereof are shown as initial flexural strengths in Table 1.

### Flexural Strength After Reheating

Next, the single-plate samples of Samples 1 to 37 were reheated at 900° C., which was a firing temperature during baking and forming of electrodes, for 20 minutes (at a temperature increase rate of 10° C./min), and after cooling, the flexural strengths were measured in the same manner as described above. Ten samples were measured for each type of the samples. Average values thereof are shown in Table 1 as flexural strengths after reheating.

Further, the average values of each of the initial flexural strengths and each of the flexural strengths after reheating were compared to calculate a strength increase rate (initial flexural strength/flexural strength after reheating×100). The results are shown in Table 1.

### Initial Permeability μ′

The ring-shaped samples of Samples 1 to 37 were placed in a permeability measurement jig (manufactured by Agilent Technologies, Inc., 16454A-s), and an initial permeability μ′ of each sample was measured at a measurement frequency of 100 kHz by using an impedance analyzer (manufactured by Agilent Technologies, Inc., E4990A). The results are shown in Table 1.

### Curie Temperature

Temperature characteristics of the initial permeability μ′ at 100 kHz of each of the ring-shaped samples of Samples 1 to 37 were measured at intervals of 5° C. within a temperature range equal to or higher than 25° C. and equal to or lower than 250° C. (i.e., from 25° C. to 250° C.) by using a thermostatic chamber STH-120 manufactured by ESPEC CORP. and an LCR meter E4980 manufactured by Keysight Technologies to determine a Curie temperature. The results are shown in Table 1.

### Insulation Resistance

Insulation resistance values of the ring-shaped samples of Samples 1 to 37 in the thickness direction were measured by using a high resistance meter 4339B manufactured by Keysight Technologies. The results are shown in Table 1.

TABLE 1

| | | | | | | | | | | | | | Flexural | |
|---|---|---|---|---|---|---|---|---|---|---|---|---|---|---|
| | | | | | | | | | | | | Initial | Strength | |
| | | | | | | | | | Initial | Curie | Insulation | Flexural | After | |
| | | | | | | | | | Perme- | Temper- | Resistance | Strength | Reheating | Strength |
| Sample | Fe₂O₃ | ZnO | NiO | CuO | MnO | CoO | Cr₂O₃ | Y₂O₃ | ability | ature | Value | N | N | Increase |
| Number | (mol %) | (mol %) | (mol %) | (mol %) | (mol %) | (mol %) | (ppm) | (ppm) | μ′ | [° C.] | [log Ω] | (n = 10) | (n = 10) | Rate |
| *1 | 49.9457 | 28.4691 | 15.4832 | 5.9935 | 0.1048 | 0.0037 | 10 | 10 | 1056 | 170 | 6 | 180 | 193 | 107% |
| 2 | 49.1466 | 28.4691 | 16.2823 | 5.9935 | 0.1048 | 0.0037 | 10 | 10 | 958 | 179 | 10 | 193 | 214 | 111% |
| 3 | 47.4485 | 28.4691 | 17.9805 | 5.9935 | 0.1048 | 0.0037 | 10 | 10 | 787 | 196 | 10 | 195 | 220 | 113% |
| 4 | 44.4517 | 28.4691 | 20.9772 | 5.9935 | 0.1048 | 0.0037 | 10 | 10 | 525 | 219 | 10 | 200 | 222 | 111% |
| 5 | 41.9544 | 28.4691 | 23.4745 | 5.9935 | 0.1048 | 0.0037 | 10 | 10 | 373 | 230 | 10 | 202 | 224 | 111% |
| *6 | 39.9566 | 28.4691 | 25.4723 | 5.9935 | 0.1048 | 0.0037 | 10 | 10 | 308 | >250 | 10 | 186 | 192 | 104% |
| *7 | 47.4485 | 44.9512 | 1.4984 | 5.9935 | 0.1048 | 0.0037 | 10 | 10 | 1 | — | 10 | 189 | 196 | 103% |
| 8 | 47.4485 | 35.9609 | 10.4886 | 5.9935 | 0.1048 | 0.0037 | 10 | 10 | 2077 | 76 | 10 | 201 | 227 | 113% |
| 9 | 47.4485 | 32.9642 | 13.4854 | 5.9935 | 0.1048 | 0.0037 | 10 | 10 | 1247 | 151 | 10 | 198 | 226 | 114% |
| 10 | 47.4485 | 26.9707 | 19.4788 | 5.9935 | 0.1048 | 0.0037 | 10 | 10 | 666 | 211 | 10 | 194 | 221 | 114% |
| 11 | 47.4485 | 21.9761 | 24.4734 | 5.9935 | 0.1048 | 0.0037 | 10 | 10 | 312 | >250 | 10 | 193 | 216 | 112% |
| *12 | 47.4485 | 14.9837 | 31.4658 | 5.9935 | 0.1048 | 0.0037 | 10 | 10 | 82 | >250 | 10 | 189 | 197 | 104% |
| *13 | 47.4485 | 28.4691 | 14.9837 | 8.9902 | 0.1048 | 0.0037 | 10 | 10 | 909 | 164 | 10 | 172 | 181 | 106% |
| 14 | 47.4485 | 28.4691 | 16.4821 | 7.4919 | 0.1048 | 0.0037 | 10 | 10 | 796 | 192 | 10 | 191 | 216 | 113% |
| 15 | 47.4485 | 28.4691 | 19.4788 | 4.4951 | 0.1048 | 0.0037 | 10 | 10 | 724 | 202 | 10 | 208 | 229 | 110% |
| *16 | 47.4485 | 28.4691 | 22.9750 | 0.9989 | 0.1048 | 0.0037 | 10 | 10 | 269 | 228 | 10 | 165 | 179 | 108% |
| *17 | 46.4825 | 27.8895 | 17.6144 | 5.8715 | 2.1384 | 0.0037 | 10 | 10 | 680 | 165 | 9 | 191 | 234 | 123% |
| 18 | 47.0867 | 28.2520 | 17.8434 | 5.9478 | 0.8665 | 0.0037 | 10 | 10 | 721 | 180 | 10 | 195 | 235 | 121% |
| 19 | 47.4775 | 28.4865 | 17.9915 | 5.9972 | 0.0437 | 0.0037 | 10 | 10 | 793 | 193 | 10 | 193 | 220 | 114% |
| *20 | 47.4961 | 28.4977 | 17.9985 | 5.9995 | 0.0044 | 0.0037 | 10 | 10 | 760 | 186 | 10 | 185 | 199 | 107% |
| *21 | 45.7423 | 27.4454 | 17.3339 | 5.7780 | 0.1010 | 3.5993 | 10 | 10 | 105 | >250 | 10 | 188 | 198 | 105% |
| 22 | 46.8669 | 28.1202 | 17.7601 | 5.9200 | 0.1035 | 1.2293 | 10 | 10 | 239 | >250 | 10 | 192 | 227 | 118% |
| 23 | 47.3324 | 28.3994 | 17.9365 | 5.9788 | 0.1045 | 0.2483 | 10 | 10 | 435 | 210 | 10 | 196 | 237 | 121% |
| 24 | 47.4501 | 28.4700 | 17.9811 | 5.9937 | 0.1048 | 0.0004 | 10 | 10 | 796 | 187 | 10 | 198 | 220 | 111% |
| *25 | 47.4502 | 28.4701 | 17.9811 | 5.9937 | 0.1048 | 0.0000 | 10 | 10 | 800 | 180 | 10 | 187 | 195 | 104% |
| *26 | 47.4485 | 28.4691 | 17.9805 | 5.9935 | 0.1048 | 0.0037 | 1500 | 10 | 732 | 203 | 10 | 187 | 199 | 106% |
| 27 | 47.4485 | 28.4691 | 17.9805 | 5.9935 | 0.1048 | 0.0037 | 800 | 10 | 756 | 199 | 10 | 191 | 207 | 108% |
| 28 | 47.4485 | 28.4691 | 17.9805 | 5.9935 | 0.1048 | 0.0037 | 600 | 10 | 804 | 192 | 10 | 190 | 235 | 124% |
| 29 | 47.4485 | 28.4691 | 17.9805 | 5.9935 | 0.1048 | 0.0037 | 50 | 10 | 784 | 195 | 10 | 201 | 229 | 114% |
| 30 | 47.4485 | 28.4691 | 17.9805 | 5.9935 | 0.1048 | 0.0037 | 5 | 10 | 779 | 193 | 10 | 193 | 211 | 109% |
| *31 | 47.4485 | 28.4691 | 17.9805 | 5.9935 | 0.1048 | 0.0037 | 0 | 10 | 788 | 194 | 10 | 190 | 199 | 105% |
| *32 | 47.4485 | 28.4691 | 17.9805 | 5.9935 | 0.1048 | 0.0037 | 10 | 1500 | 550 | 220 | 10 | 189 | 198 | 105% |
| 33 | 47.4485 | 28.4691 | 17.9805 | 5.9935 | 0.1048 | 0.0037 | 10 | 800 | 735 | 205 | 10 | 192 | 208 | 108% |
| 34 | 47.4485 | 28.4691 | 17.9805 | 5.9935 | 0.1048 | 0.0037 | 10 | 600 | 750 | 200 | 10 | 196 | 239 | 122% |
| 35 | 47.4485 | 28.4691 | 17.9805 | 5.9935 | 0.1048 | 0.0037 | 10 | 50 | 791 | 196 | 10 | 197 | 224 | 114% |
| 36 | 47.4485 | 28.4691 | 17.9805 | 5.9935 | 0.1048 | 0.0037 | 10 | 5 | 790 | 195 | 10 | 195 | 215 | 110% |
| *37 | 47.4485 | 28.4691 | 17.9805 | 5.9935 | 0.1048 | 0.0037 | 10 | 0 | 805 | 190 | 10 | 185 | 197 | 106% |

In Table 1, the samples marked with * are comparative examples out of the scope of the present disclosure.

As shown in Table 1, for Samples 2 to 5, 8 to 11, 14, 15, 18, 19, 22 to 24, 27 to 30, and 33 to 36 containing Fe, Cu, Zn, Mn, Co, Ni, Y, and Cr in predetermined ranges, a ceramic composition having an initial flexural strength equal to or more than 190 N, a flexural strength after reheating equal to or more than 200 N, and an electric resistance equal to or more than 10 by logarithmic expression can be obtained.

Further, for Samples 2 to 4, 9, 10, 14, 15, 18, 19, 23, 24, 27 to 30, and 33 to 36 each of which contains Fe of an amount equal to or more than 44.4 mol % and equal to or less than 49.2 mol % (i.e., from 44.4 mol % to 49.2 mol %) in terms of Fe₂O₃, Zn of an amount equal to or more than 26.9 mol % and equal to or less than 33.0 mol % (i.e., from 26.9 mol % to 33.0 mol %) in terms of ZnO, and Co of an amount equal to or more than 0.0004 mol % and equal to or less than 0.2500 mol % (i.e., from 0.0004 mol % to 0.2500 mol %) in terms of CoO, a ceramic composition having an initial flexural strength equal to or more than 190 N, a flexural strength after reheating equal to or more than 200 N, an electric resistance equal to or more than 10 by logarithmic expression, an initial permeability μ′ equal to or more than 400, and a Curie temperature equal to or more than 150° C. can be obtained.

In addition, for Samples 2 to 5, 8 to 11, 14, 15, 18, 19, 22 to 24, 28 to 30, and 34 to 36 containing Y of an amount equal to or more than 5 ppm and equal to or less than 600 ppm (i.e., from 5 ppm to 600 ppm) in terms of Y₂O₃ and Cr of an amount equal to or more than 10 ppm and equal to or less than 600 ppm (i.e., from 10 ppm to 600 ppm) in terms of Cr₂O₃, a ceramic composition having a flexural strength after reheating equal to or more than 210 N and a strength increase rate equal to or more than 110% when the initial flexural strength and the flexural strength after reheating are compared can be obtained.

What is claimed is:

1. A ceramic composition comprising:
Fe; Cu; Zn; Mn; Co; Ni; Y; and Cr,
wherein
when the Fe, the Cu, the Zn, the Mn, the Co, and the Ni are expressed in terms of Fe₂O₃, CuO, ZnO, MnO, CoO, and NiO, respectively, and a total amount of the Fe₂O₃, the CuO, the ZnO, the MnO, the CoO, and the NiO is set to 100 mol %, the ceramic composition includes the Fe of an amount from 41.9 mol % to 49.2 mol % in terms of the Fe₂O₃, the Cu of an amount from 4.4 mol % to 7.5 mol % in terms of the CuO, the Zn of an amount from 21.9 mol % to 36.0 mol % in terms of the ZnO, the Mn of an amount from 0.043 mol % to 0.867 mol % in terms of the MnO, the Co of an amount from 0.0004 mol % to 1.2293 mol % in terms of the CoO, and the Ni of the remaining amount, and
relative to 100 parts by weight of the total amount of the Fe₂O₃, the CuO, the ZnO, the MnO, the CoO, and the NiO, the ceramic composition includes the Y of an amount from 5 ppm to 800 ppm in terms of Y₂O₃ and the Cr of an amount from 5 ppm to 800 ppm in terms of Cr₂O₃.

2. The ceramic composition according to claim 1, wherein
the Fe is of an amount from 44.4 mol % to 49.2 mol % in terms of the Fe₂O₃, the Zn is of an amount from 26.9 mol % to 33.0 mol % in terms of the ZnO, and the Co is of an amount from 0.0004 mol % to 0.2500 mol % in terms of the CoO.

3. The ceramic composition according to claim 1, wherein
the Y is of an amount from 5 ppm to 600 ppm in terms of the Y₂O₃, relative to 100 parts by weight of the total amount of the Fe₂O₃, the CuO, the ZnO, the MnO, the CoO and, the NiO.

4. The ceramic composition according to claim 1, wherein
the Cr is of an amount from 10 ppm to 600 ppm in terms of the Cr₂O₃, relative to 100 parts by weight of the total amount of the Fe₂O₃, the CuO, the ZnO, the MnO, the CoO, and the NiO.

5. A coil component comprising:
a ceramic core including the ceramic composition according to claim 1.

6. The coil component according to claim 5,
wherein the ceramic core includes a winding core portion extending in a length direction, and a pair of flange portions at both end portions of the winding core portion opposed to each other in the length direction, each of the flange portions including an inner end surface facing the winding core portion side in the length direction, an outer end surface on an opposite side to the inner end surface in the length direction, a pair of side surfaces opposed to each other in a width direction, and a top surface and a bottom surface opposed to each other in a height direction,
a terminal electrode is on at least the bottom surface of each of the flange portions of the ceramic core, and
a wire is wound around the winding core portion of the ceramic core, and an end portion of the wire is electrically coupled to the terminal electrode.

7. A coil component comprising:
a ceramic core including the ceramic composition according to claim 2.

8. A coil component comprising:
a ceramic core including the ceramic composition according to claim 3.

9. A coil component comprising:
a ceramic core including the ceramic composition according to claim 4.

10. The coil component according to claim 7,
wherein the ceramic core includes a winding core portion extending in a length direction, and a pair of flange portions at both end portions of the winding core portion opposed to each other in the length direction, each of the flange portions including an inner end surface facing the winding core portion side in the length direction, an outer end surface on an opposite side to the inner end surface in the length direction, a pair of side surfaces opposed to each other in a width direction, and a top surface and a bottom surface opposed to each other in a height direction,
a terminal electrode is on at least the bottom surface of each of the flange portions of the ceramic core, and
a wire is wound around the winding core portion of the ceramic core, and an end portion of the wire is electrically coupled to the terminal electrode.

11. The coil component according to claim 8,
wherein the ceramic core includes a winding core portion extending in a length direction, and a pair of flange portions at both end portions of the winding core portion opposed to each other in the length direction, each of the flange portions including an inner end surface facing the winding core portion side in the length direction, an outer end surface on an opposite side to the inner end surface in the length direction, a pair of side surfaces opposed to each other in a width direction, and a top surface and a bottom surface opposed to each other in a height direction,
a terminal electrode is on at least the bottom surface of each of the flange portions of the ceramic core, and
a wire is wound around the winding core portion of the ceramic core, and an end portion of the wire is electrically coupled to the terminal electrode.

12. The coil component according to claim 9,
wherein the ceramic core includes a winding core portion extending in a length direction, and a pair of flange portions at both end portions of the winding core portion opposed to each other in the length direction, each of the flange portions including an inner end surface facing the winding core portion side in the length direction, an outer end surface on an opposite side to the inner end surface in the length direction, a pair of side surfaces opposed to each other in a width direction, and a top surface and a bottom surface opposed to each other in a height direction,
a terminal electrode is on at least the bottom surface of each of the flange portions of the ceramic core, and
a wire is wound around the winding core portion of the ceramic core, and an end portion of the wire is electrically coupled to the terminal electrode.
